(19) United States
(12) Patent Application Publication
(10) Pub. No.: US 2009/0015126 A1
(43) Pub. Date: Jan. 15, 2009

(54) LAMP WITH DOUBLE FILAMENT

(75) Inventor: Eric Gueusquin, Vatimont (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,712

(22) PCT Filed: Dec. 29, 2004
(86) PCT No.: PCT/IB2004/004316

§ 371 Date: Jun. 22, 2006

(30) Foreign Application Priority Data
Jan. 5, 2004 (EP) 04300002.5

(51) Int. Cl. H01J 1/94

(52) U.S. Cl. 313/279

(57) ABSTRACT

The present invention relates to a lamp comprising a lamp vessel (101) having an inner diameter and an incandescent body (102) arranged in the lamp vessel and connected to current supply conductors (106). The lamp further comprises a filament (103) arranged around said incandescent body along at least half the length of said incandescent body, which filament has an outer diameter substantially equal to the inner diameter of the lamp vessel.

### FIELD OF THE INVENTION

The present invention relates to a tubular lamp.

The invention finds its application, for example, in a heating system designed for industrial purposes such as curing of synthetic resins by heat, drying of paper, baking of paints or semiconductors manufacturing.

### BACKGROUND OF THE INVENTION

Patent US 2003/0001475 published Jan. 2, 2003 describes a tubular lamp comprising a lamp vessel with an incandescent body arranged in the lamp vessel and connected to current supply conductors. In order to locate axially the incandescent body within the lamp vessel, the tubular lamp comprises supports added around the incandescent body periodically along the incandescent body length. These supports reduce the sagging of the incandescent body that occurs when the incandescent body is heated at a relatively high temperature. Reducing the sagging of the incandescent body is important, because the sagging reduces the lifetime of the tubular lamp. However, the applicant has noticed that, in a tubular lamp such as described in US 2003/0001475, sagging of the incandescent body still occurs, especially when the tubular lamp has been used for a relatively long time. Moreover, manufacturing such a lamp requires a long and complicated process, as it requires many steps for adding the supports one by one around the incandescent body.

### SUMMARY OF THE INVENTION

It is an object of the invention to provide a lamp which has an improved lifetime and which is easy to manufacture.

To this end, the invention proposes a lamp comprising a lamp vessel having an inner diameter, an incandescent body arranged in the lamp vessel and connected to current supply conductors, and a filament arranged around said incandescent body along at least half the length of said incandescent body and having an outer diameter substantially equal to the inner diameter of the lamp vessel.

According to the invention, a filament is added around the incandescent body, which filament is in contact or close to the walls of the lamp vessel. As a consequence, when the incandescent body is heated at a relatively high temperature and sagging occurs, this sagging is absorbed by the filament, which has a plurality of contact points with the lamp vessel. As the filament is arranged around a substantial part of the incandescent body, the sagging is reduced compared with the lamps of the prior art, where supports are provided only locally around the incandescent body. Moreover, the manufacturing process of a lamp in accordance with the invention is simplified, because only one step is required, which step consists in arranging the filament around the incandescent body.

In a first embodiment, the incandescent body has an outer diameter and the filament has an inner diameter which is larger than or equal to the outer diameter of the incandescent body. According to this first embodiment, the manufacturing process of the lamp is simplified, because the incandescent body can simply be threaded through the filament.

In a second embodiment, the incandescent body has an outer diameter and the filament has an inner diameter which is lower than the outer diameter of the incandescent body, the incandescent body being screwed in the filament. According to this embodiment, the lamp can be used in a vertical position.

Preferably, the lamp vessel is made from quartz. The lamp in accordance with the invention can then be used at high temperature, because the quartz resist to relatively high temperatures. This reduces the risk of burst of the lamp, even if the filament is in contact with the lamp vessel.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIGS. 1a and 1b show a lamp in accordance with a first embodiment of the invention;

FIGS. 2a and 2b show another lamp in accordance with a first embodiment of the invention;

FIGS. 3a and 3b show a lamp in accordance with a second embodiment of the invention.

### DETAILED DESCRIPTION OF THE INVENTION

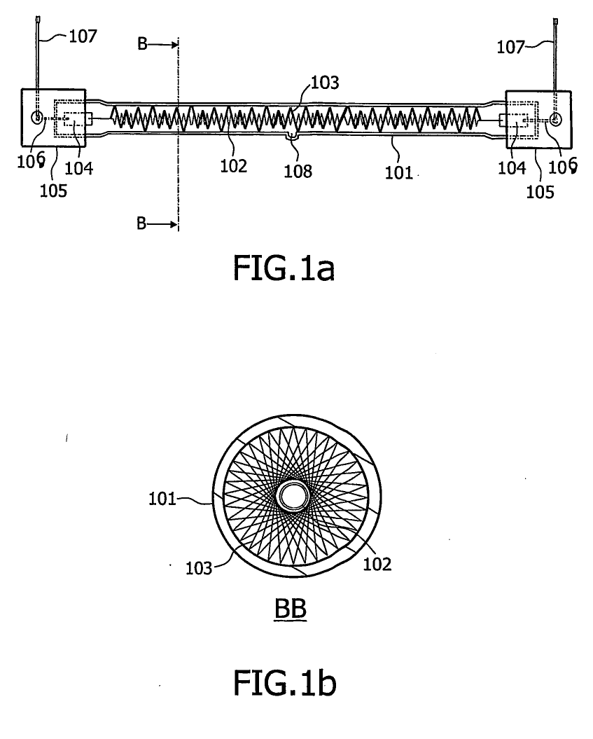

A lamp in accordance with a first embodiment of the invention is depicted in FIGS. 1a and 1b. FIG. 1b is an enlarged cross-section in the plane BB of FIG. 1a. For reasons of convenience, the respective dimensions of the elements of the lamp may not correspond on FIG. 1a and FIG. 1b. This lamp comprises a lamp vessel 101, an incandescent body 102, a filament 103 and current supply conductors 106. The lamp further comprises caps 105, foils 104, current wires 107 and an exhausting pipe 108. Although a double-ended lamp has been represented in FIG. 1a, the invention may be applied to a single-ended lamp.

The incandescent body 102, which is for example a tungsten wire, has its extremities connected to the foils 104, which are for example pieces of molybdenum to which the extremities of the incandescent body 102 are welded. Current supply conductors 106 are also welded to the foils 104. The current supply conductors 106 are connected to the current wires 107. This can be done by welding a current supply conductor 106 to a current wire 107, through a hole of a cap 105. Such a cap 105 is described in patent EP 0345890. Alternatively, the extremity of the incandescent body 102 serves as current supply conductor and is directly connected to the current wire 107.

The lamp vessel 101 is filled with a high-pressure discharge gas, such as argon, and comprises a small quantity of a halide substance in order to prevent darkening of the lamp vessel 101, due to deposition of gaseous tungsten. The lamp of FIG. 1a comprises an exhausting pipe 108. The exhausting pipe 108 is due to the manufacturing process of the lamp vessel 101. Actually, during the manufacturing process, it is usual to make a hole in the lamp vessel 101, in order to fill the lamp vessel with gas. The presence of the exhausting pipe 108 is due to the hole made during the manufacturing process.

In the lamp of FIGS. 1a and 1b, the filament 103 is a star-shaped filament. Such a filament is known to those skilled in the art. For example, the applicant has made an halogen lamp commercially available under reference 17010Z, which comprises such a star-shaped filament. The incandescent body 102, which in this example is a tungsten coiled wire, is threaded through the filament 103. To this end, the inner diameter of the filament 103 is higher than the outer diameter of the incandescent body 102, as can be seen in FIG. 1b. As a consequence, manufacturing such a lamp is easy, because threading the incandescent body 102 through the filament 103 can be performed in a single step.

In the lamp of FIGS. 1a and 1b, the outer diameter of the filament 103 is equal to the inner diameter of the lamp vessel 101. Hence, the filament 103 has a plurality of contact points with the lamp vessel 101. When current passes through the incandescent body 102, said incandescent body is heated and thus tends to sag under gravity. Thanks to the filament 103, the displacement of the incandescent body due to sagging is relatively small, because the incandescent body can only move in the inner diameter of the filament 103. As a consequence, the sagging is reduced and the lifetime of the lamp is increased.

In this example, the filament 103 is arranged around the incandescent body 102 all along the length of said incandescent body 102. It should be noted that the filament 103 may be arranged along a smaller portion of the incandescent body 102. However, in order to achieve good reduction of the sagging by using a filament 103 arranged around the incandescent body 102, the length of the filament 103 should be at least half of the length of the incandescent body 102, preferably more than 75 percent of the length of the incandescent body 102.

It should also be noticed that the outer diameter of the filament 103 may not be strictly equal to the inner diameter of the lamp vessel 101. Preferably, the outer diameter of the filament 103 is slightly lower than the inner diameter of the lamp vessel 101, which makes it easier to thread the filament 103 through the lamp vessel 101. In order to achieve good reduction of the sagging, the outer diameter of the filament 103 should not be lower than 90 percent of the inner diameter of the lamp vessel 101. Hence, the expression “substantially equal to” should be understood as meaning “not lower than 90 percent of”.

Advantageously, at least one extremity of the filament 103 is attached to the incandescent body 102. This can be performed, for example, by means of conventional welding. This reduces the relative movement that may occur between the filament 103 and the incandescent body 102 in the lamp. Moreover, the filament 103 can be attached to the incandescent body 102 before manufacturing the lamp, which makes it possible to provide the filament 103 and the incandescent body 102 as a single piece that is intended to replace the conventional incandescent body of the conventional lamps.

During operation of the lamp of FIGS. 1a and 1b, a current passes through the incandescent body 102, which is heated and emits a radiation, which radiation depends on the nature of the incandescent body 102. As the filament 103 is in contact with the incandescent body 102, a current also passes through the filament 103, which is thus heated and emits a radiation. As a consequence, the radiation emitted by the lamp is a combination of the radiation emitted by the incandescent body 102 and the radiation emitted by the filament 103. By suitably choosing the materials and shapes of the incandescent body 102 and the filament 103, it is possible to obtain a desired spectrum of the radiation emitted by the lamp. This can be useful, for example, in applications such as the drying of paints that require two types of radiation such as short infra-red and near-infrared, known as IR-A and IR-B.

During operation, the filament 103 thus also reaches a relatively high temperature. However by suitably choosing the shape of said filament 103, said temperature can be kept within limits to which the lamp vessel 101 resist. In the example of FIG. 1a, where the incandescent body 102 is a coiled wire, the pitch of the filament 103 is preferably more than twice the pitch of the incandescent body 102. In this way, the filament 103 has a resistivity that is such that the current preferably passes through the incandescent body 102. Moreover, the contacts between the filament 103 and the lamp vessel 101 are only punctual, which is less damaging for the lamp vessel than the contacts that would occur between the incandescent body 102 and the lamp vessel 101 during sagging, in the absence of the filament 103. Due to the temperature reached by the second filament 103 during operation, it is preferable that the lamp vessel resist to relatively high temperature. A lamp vessel made from quartz is particularly suitable for this purpose.

The lamp in accordance with the invention is particularly advantageous in applications where the cut off time of radiated energy should be as small as possible. This is the case, for example, in a heating system for semiconductors. The applicant has noticed that the cut off time of radiated energy in a lamp in accordance with the invention is more than 10 percent lower that in a lamp of the prior art. This can be explained by the fact that the filament 103 plays the role of a heat sink for the incandescent body 102.

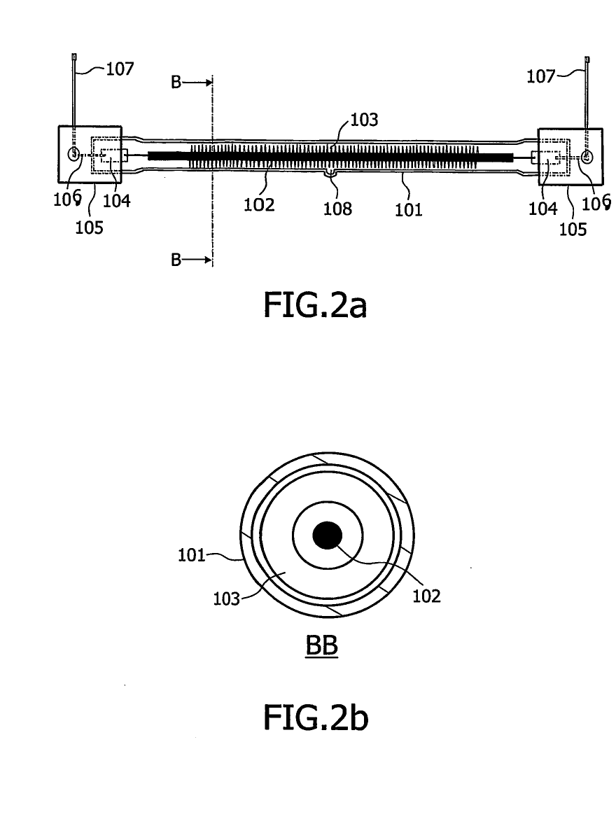

Another lamp in accordance with a first embodiment of the invention is depicted in FIGS. 2a and 2b. In this example, the incandescent body 102 is a carbon bar and the filament 103 is a coiled wire. As can be seen in FIG. 2b, there is a slight clearance between the filament 103 and the lamp vessel 101, which simplifies the mounting of said filament 103 inside the lamp vessel 101.

As can be seen in FIG. 2a, the filament 103 is arranged around the incandescent body 102 along a substantial portion of the length of said incandescent body 102. In this example, the filament 103 is arranged symmetrically with respect to the centre of the incandescent body 102. Although this is not required according to the invention, this is preferred. Actually, during operation the portions of the incandescent body 102 that show the highest sagging are located around the centre of the incandescent body 102.

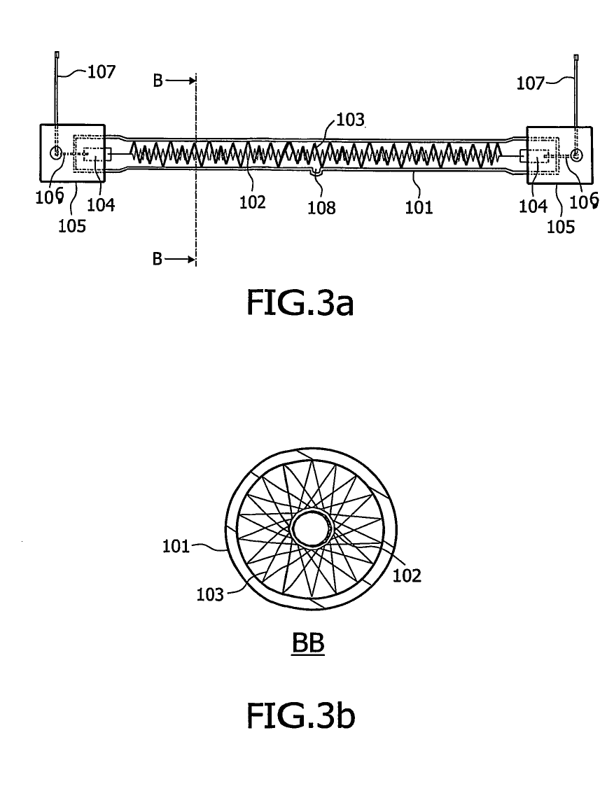

A lamp in accordance with a second embodiment of the invention is depicted in FIGS. 3a and 3b. As can be seen in FIG. 3b, the incandescent body 102 has an outer diameter that is larger than the inner diameter of the filament 103. According to this second embodiment of the invention, the incandescent body 102 is screwed in the filament 103. As a consequence, the relative movement between the filament 103 and the incandescent body 102 is strongly limited. This makes it in particular possible to use such a lamp in a vertical position. Actually, even under effect of the gravity, the filament 103 remains in place around the incandescent body.

Moreover, the filament 103 may be chosen in such a way that it is more rigid that the incandescent body 102. This limits the compression of the incandescent body 102 that occurs when the lamp is used in vertical position, because of the gravity. Actually, if the filament 103 is chosen relatively rigid, its compression under gravity is relatively low. As the incandescent body 102 is screwed in the filament 103, this also limits the compression of the filament 102. Alternatively, the filament 103 may be maintained in position in the lamp by means of droplets formed in the lamp vessel 101. In this case, no condition on the rigidity of the filament 103 is required.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A lamp comprising a lamp vessel (101) having an inner diameter, an incandescent body (102) arranged in the lamp vessel and connected to current supply conductors (106), and a filament (103) arranged around said incandescent body along at least half the length of said incandescent body and having an outer diameter substantially equal to the inner diameter of the lamp vessel.

2. A lamp as claimed in claim 1, wherein the incandescent body has an outer diameter and the filament has an inner diameter which is larger than or equal to the outer diameter of the incandescent body.

3. A lamp as claimed in claim 1, wherein the incandescent body has an outer diameter and the filament has an inner diameter which is lower than the outer diameter of the incandescent body, the incandescent body being screwed in the filament.

4. A lamp as claimed in claim 1, wherein the lamp vessel is made from quartz.
